(19) United States
(12) Patent Application Publication
(10) Pub. No.: US 2023/0020779 A1
(43) Pub. Date: Jan. 19, 2023

(54) METHOD FOR DYNAMIC CATEGORIZATION THROUGH NATURAL LANGUAGE PROCESSING

(71) Applicant: ROSOKA SOFTWARE, INC., Herndon, VA (US)

(72) Inventors: Gregory F. ROBERTS, Herndon, VA (US); Michael Allen SORAH, Herdon, VA (US)

(21) Appl. No.: 17/785,038

(22) PCT Filed: Aug. 14, 2020
(86) PCT No.: PCT/US2020/046369

§ 371 Date: Jun. 13, 2022

Related U.S. Application Data
(60) Provisional application No. 62/888,386, filed on Aug. 16, 2019.

(51) Int. Cl. G06F 16/35; G06F 40/40; G06F 40/284

(52) U.S. Cl. CPC G06F 16/355; G06F 40/40; G06F 40/284

(57) ABSTRACT

Dynamic categorization of documents from a semi-static classification taxonomy through the use of key terms, concepts, and entities. Dynamic categorization is a method for retrieving documents that are relevant to a specific category, which can be defined at the time the documents are needed. This is in contrast to a priori sorting and tagging (identifying) documents as to what categories they belong. The categories can be defined not just as a set of key words but may also include phrases, entities and/or relationships found in the document(s), complex field queries, weighted queries against words, as well as exclusion conditions.

### CROSS REFERENCE TO RELATED APPLICATION

This application is a national phase filing under 35 U.S.C. § 371 of International Application No. PCT/US2020/046369, filed Aug. 14, 2020, which claims the benefit of U.S. Provisional Application No. 62/888,386 filed Aug. 16, 2019. The entire content of the above-referenced application is hereby incorporated by reference.

### FIELD

Some exemplary embodiments may generally relate to dynamically identifying documents to a category or set of topics defined by a user.

### BACKGROUND

In the modern world in which exponential growth of unstructured data includes documents, emails, and internet pages, there is a need to systematically extract only value specific information from the volumes of available data. Conventionally, the amount of time and effort involved with exacting value specific information from the volumes of available information has been a problem.

Previous solutions have taken the stance that all information has an equal value when processed, stored, and retrieved, and that categorized information would also have equal value when processed stored and retrieved. Information within the documents is understood to be static and unchanging over time. However, the specific value or importance of the information within the documents is better determined at the time when an answer or response is needed, rather than when the document was first retrieved, stored or saved. The following two sentences provide an illustrative example, “Juju Bean owns a 35 mm gun which she keeps in her KIA” and “Juju was seen in the Paris Hilton.” Each of the two sentences may have equal value to similar information when obtained. However, an investigator attempting to identify who committed a crime at a specific hotel using a specific gun may now place a higher value on these.

Limitations exist from current methods of categorizing data at the time of receipt or initial processing. The limitations present a need for dynamic categorization.

### SUMMARY

In accordance with some embodiments, a method may include receiving a document at a natural language processing engine. The natural language processing engine extracts text from the document. The method may further include indexing the extracted text at a data store. The method may further include populating a query based on the indexed text and a category descriptor. The method may further include categorizing the document based on the query.

In accordance with some embodiments, an apparatus may include at least one processor and at least one memory including computer program code. The at least one memory and the computer program code may be configured to, with the at least one processor, cause the apparatus to perform at least receiving a document at a natural language processing engine. The natural language processing engine extracts text from the document. The at least one memory and the computer program code may be further configured to, with the at least one processor, cause the apparatus to perform at least indexing the extracted text at a data store. The at least one memory and the computer program code may be further configured to, with the at least one processor, cause the apparatus to perform at least populating a query based on the indexed text and a category descriptor. The at least one memory and the computer program code may be further configured to, with the at least one processor, cause the apparatus to at perform least categorizing the document based on the query.

In accordance with some embodiments, an apparatus may include means for receiving a document at a natural language processing engine. The natural language processing engine extracts text from the document. The an apparatus may further include means for indexing the extracted text at a data store. The apparatus may further include means for populating a query based on the indexed text and a category descriptor. The apparatus may further include means for categorizing the document based on the query.

In accordance with some embodiments, a non-transitory computer readable medium may be encoded with instructions that may, when executed in hardware, perform a method. The method may include receiving a document at a natural language processing engine. The natural language processing engine extracts text from the document. The method may further include indexing the extracted text at a data store. The method may further include populating a query based on the indexed text and a category descriptor. The method may further include categorizing the document based on the query.

In accordance with some embodiments, an apparatus may include circuitry configured to perform receiving a document at a natural language processing engine. The natural language processing engine extracts text from the document. The circuitry may be further configured to perform indexing the extracted text at a data store. The circuitry may be further configured to perform populating a query based on the indexed text and a category descriptor. The circuitry may be further configured to perform categorizing the document based on the query.

### BRIEF DESCRIPTION OF THE DRAWINGS

For proper understanding of example embodiments, reference should be made to the accompanying drawings, wherein:

FIG. 1 illustrates an example flow diagram, according to an embodiment;

FIG. 2 illustrates example sets of searchable fields from natural language processing, according to an embodiment;

FIG. 3 illustrates an example category description population using cluster analysis, according to certain embodiments;

FIG. 4 illustrates an example of forming category description using a document's salient terms, according to an embodiment;

FIG. 5 illustrates an example taxonomic structure, according to certain embodiments.

FIGS. 6a-c illustrate several views of an example dynamic categorization based on a semi-static classification taxonomy, according to certain embodiments.

FIG. 7 illustrates an example flow diagram, according to certain embodiments.

### DETAILED DESCRIPTION

Dynamic Categorization is a method and set of processes for being able to dynamically identify documents that belong to, or have membership with, user defined category or sets of topics. A user can add topics to a semi-static classification taxonomy and provide subcategories, or extend existing categories, by adding specific terms, concepts, and entities which represent those categories.

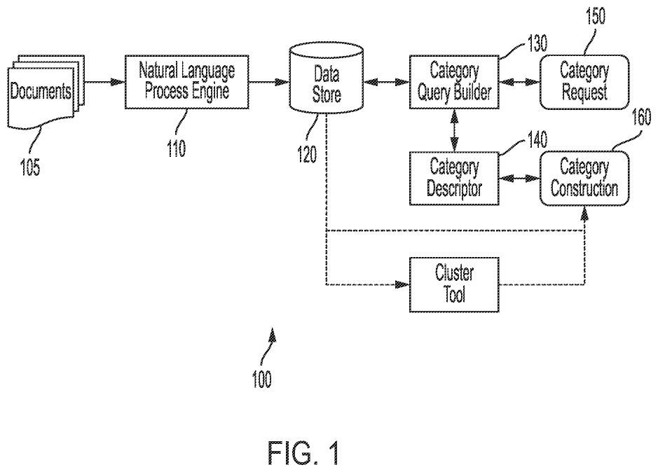

FIG. 1 illustrates an example flow diagram 100, according to an embodiment. In certain example embodiments, the flow diagram 100 of FIG. 1 shows components of a system and highlights the categorization performed upon retrieval of the documents based on the results of a Natural Language Processing (NLP).

As illustrated in FIG. 1, dynamic categorization may include a NLP engine 110 to extract and normalize text from document(s) 105 (e.g., the text contained in a word document). The NLP engine 110 may also identify the languages in the document and provide a “gloss” or base language meaning. Entities (e.g., PEOPLE, PLACES, ORGANIZATIONS, WEAPONS, DRUGS, etc. . . . ), concepts mentioned in the document, and relationships in the document between the entities are identified by the NLP engine 110. The NLP engine 110 also measures the salience or importance of each Entity or concept within the document(s).

A Data Store 120 capable of indexing extracted NLP data fields as well as providing a text index of the text and “gloss” and a service to populate a query template in a category query builder 130 with a query of the category descriptor 140 (the category taxonomy) may also be included in the dynamic categorization. The dynamic categorization may use a user interface to populate the category taxonomy and an interface to request 150 and display the documents that belong to members of the category. A document can be a member of multiple categories. The dynamic categorization may also include a cluster tool 150. As will be discussed below, a cluster tool 150 may perform a cluster analysis to populate the category description. As will be discussed below, a category may be constructed in the category constructor 160.

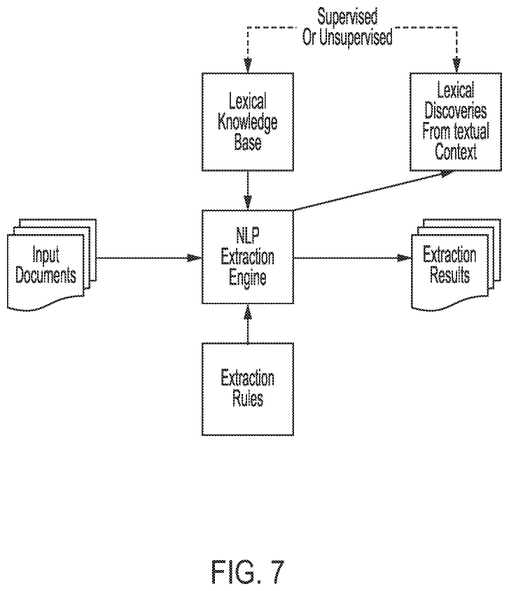

FIG. 7 illustrates a Natural Language Processing extraction engine, which receives input documents, extraction rules, and lexical knowledge. The Natural Language Processing extraction engine outputs extraction results and lexical discoveries from textual context. A person of ordinary skill in the art would understand that standard NLP capable of extracting the relationships between two entities as a predicate may be used in certain embodiments. Other NLP engines that extract the form of a predicated, subject, and object may also be used, according to certain embodiments. Although several NLP engines that extract relationships could be used, there are a some conventional NLP engines that only identify entities, or entities and co-occurrences in a document or paragraph that may require further modifications to practice certain embodiments.

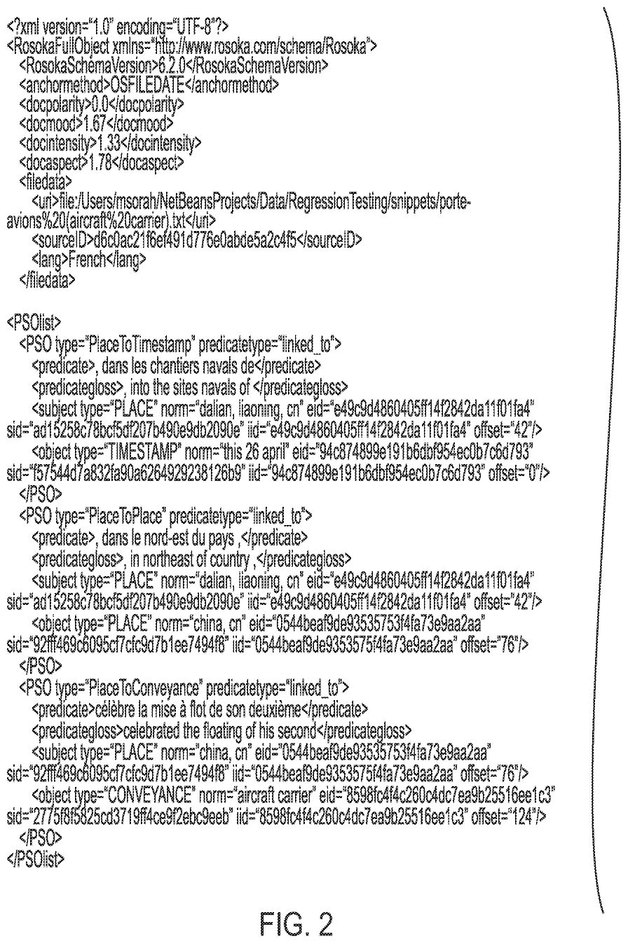

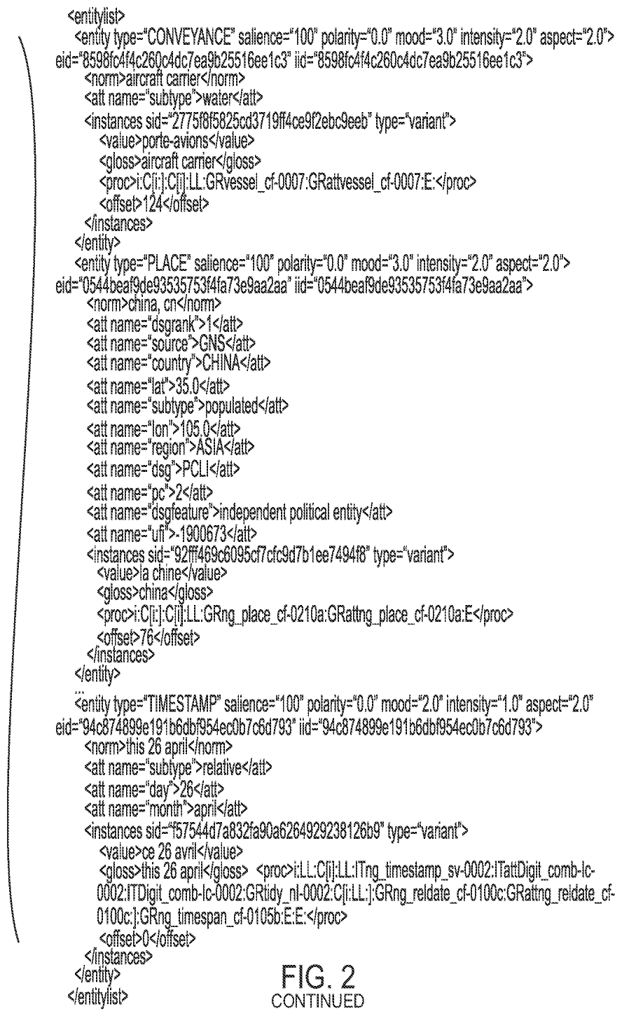

FIG. 2 illustrates example sets of searchable fields from natural language processing, according to an embodiment. Certain example embodiments use the NLP Extraction is shown in FIG. 2. Any of the fields available in the NLP output may be used as consideration for membership or exclusion within a category. This includes the text and gloss and/or a “text index” of the text or gloss fields. In certain embodiments, the categorization is not dependent on the text indexes. The NLP output is stored in the database without additional processing, other than the processing provided by any Relational Database Management System (RDBMS) or NoSQL data store search engine.

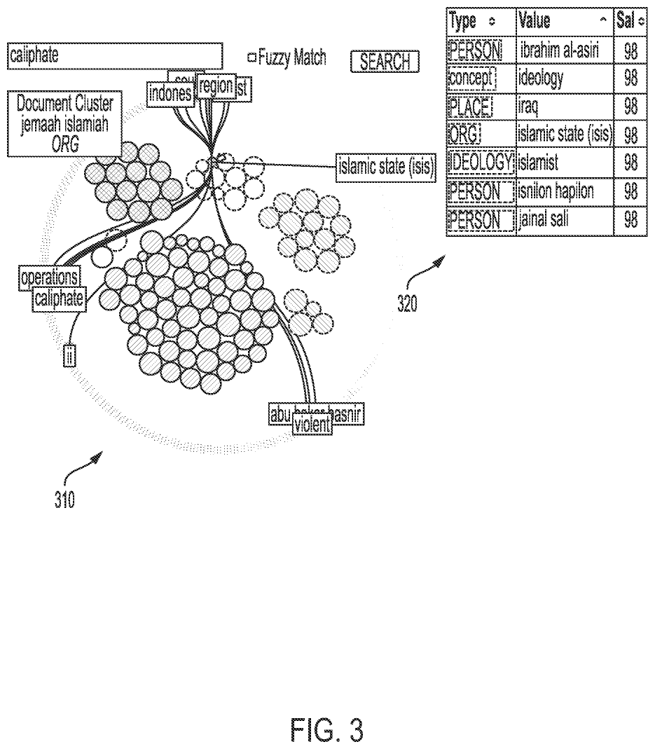

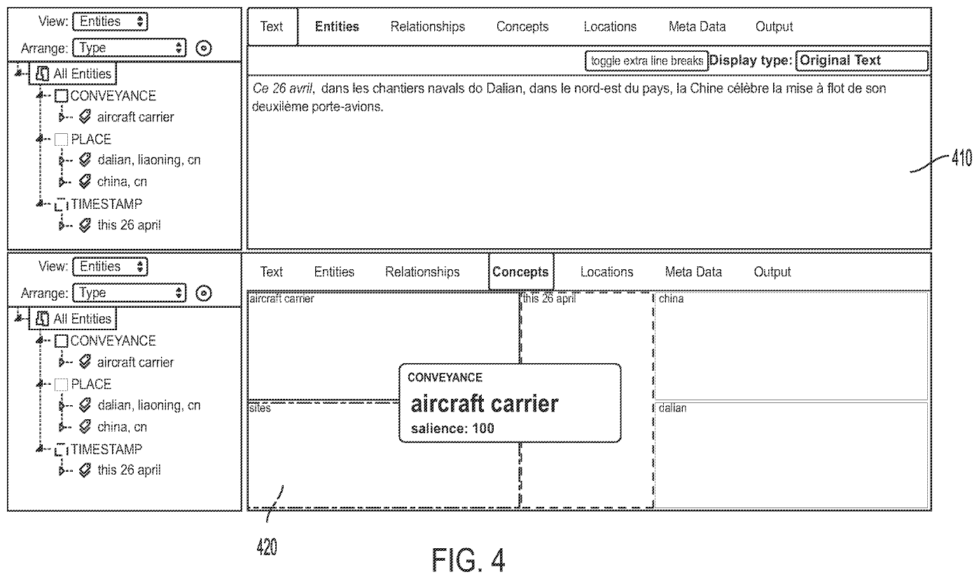

To construct the category descriptor, a user interface is used to populate a list of “must,” “should,” and/or “should not” terms for each category item in a taxonomic hierarchy. The lists can be created either by typing in the conditions directly, populated based on a set of documents, pointing and clicking on document presentations as a result of a query, or by performing co-occurrence analysis. Examples of certain category descriptor forming techniques are show in FIGS. 3 and 4. FIG. 3 illustrates using a cluster analysis to populate a category description, according to an embodiment. FIG. 3 shows an example of using a cluster tool to look for terms, concepts, and entities that commonly co-occur with a particular item (e.g., “caliphate”) across a collection of documents. A simple mouse click allows the term or entity to be used in the category description as either an inclusionary item or exclusionary item. The co-occurrence user interface may be graphical, as displayed in cluster 310, or as a list 320. In the graphical display the relative salience provide size of the bubble, whereas the color of the bubble may be indicative of the type.

FIG. 4 illustrates a category description using the salient terms of the documents. Since the categorization in performed dynamically at retrieval time, category descriptors are easily refined. To construct a category, for example, “Chinese Aircraft Carrier” based on a document as a starting point, the NLP engine is used to perform extraction. The top interface 410 of FIG. 4 illustrates the original text as with highlighted extract markups. The bottom interface 420 shows a meat map with the relative salience of each of the important terms. The example continues by selecting the terms “air craft carrier” as a must have term, with the PLACE location of “China” and “Delian” as “should have terms.” This same view may also be used to rapidly identify exclusionary terms. For example, excluding the terms “toy” or “model” would eliminate toys and models, and likely result in military equipment.

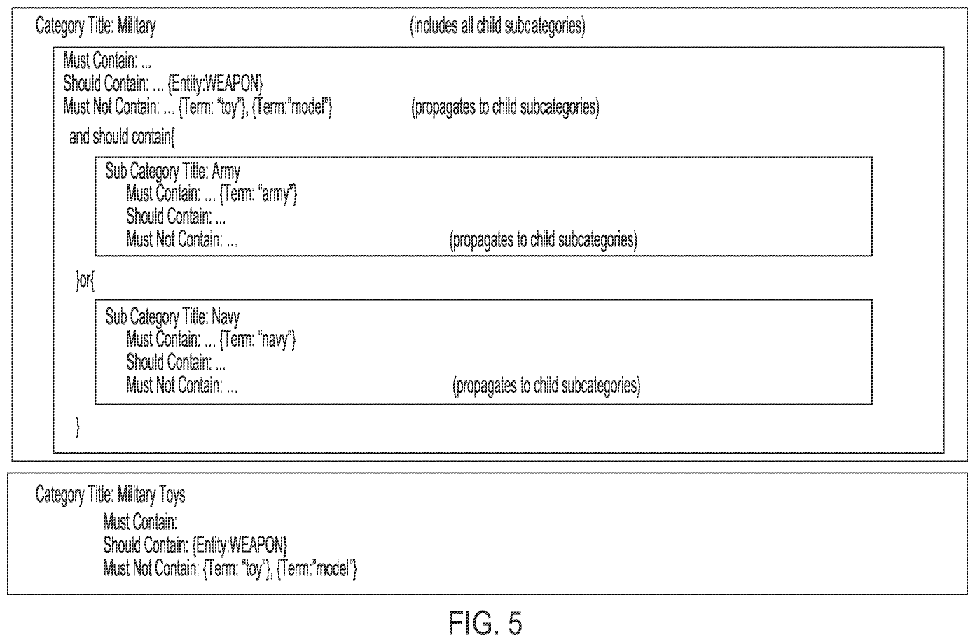

Queries may be based on the type of request to retrieve the set of documents that are members of a category. The Queries may be built from a hierarchical pattern and may be populated with the taxonomy of items to make categories, and subcategories, sub-subcategories, etc. . . . . A parent category is the Boolean “should” of all of the child categories. Selecting subcategory is a simple prune of all of the “nibbling” subcategories at the same hierarchy level (and their subordinates). The conditions may be any field from the NLP extraction, or the text or gloss, as shown in FIG. 5. FIG. 5 illustrates an example taxonomic structure, according to certain embodiments. Since any of the fields from the NLP output can be used in the query, membership to a given category is not affected by the actual language of the documents and membership is determined at the time of retrieval.

Dynamic Categorization indexes the terms and concepts at a higher level than just a string, therefore the actual language of the document does not matter. If a curator were to add, for example, “dog”, the dynamic categorization would understand to index any French documents with “chien” (the French word for dog) because the dynamic categorization is run against the native language of the document, as well as the gloss.

Document membership to a category is determined at the time of retrieval, rather than at the time of storage or the time of indexing, allowing category definitions to be added, changed, deleted, without requiring the document to be reprocessed or re-indexed. Dynamic Categorization's category index is truly dynamic. There is no down-time period from adding terms, concepts, and entities to being able to query on those categories. Conversely, requiring those terms would force the topic category to only be about toys or model aircraft carriers.

Dynamic Categorization can index categories based on entities. For example, if a PERSON entity, like “Paris Hilton” were added, the category would only index documents that include “Paris Hilton” where that Paris Hilton is a person, not the place or FACILITY located in France. The entities can be Geospatial in nature as the “Paris Hilton” FACILITY has coordinates that can be used as membership or exclusion from the category. Similarly, the entities can be temporal in nature, allowing the category membership to be based on time windows. This feature may use an NLP process to identify the relationships.

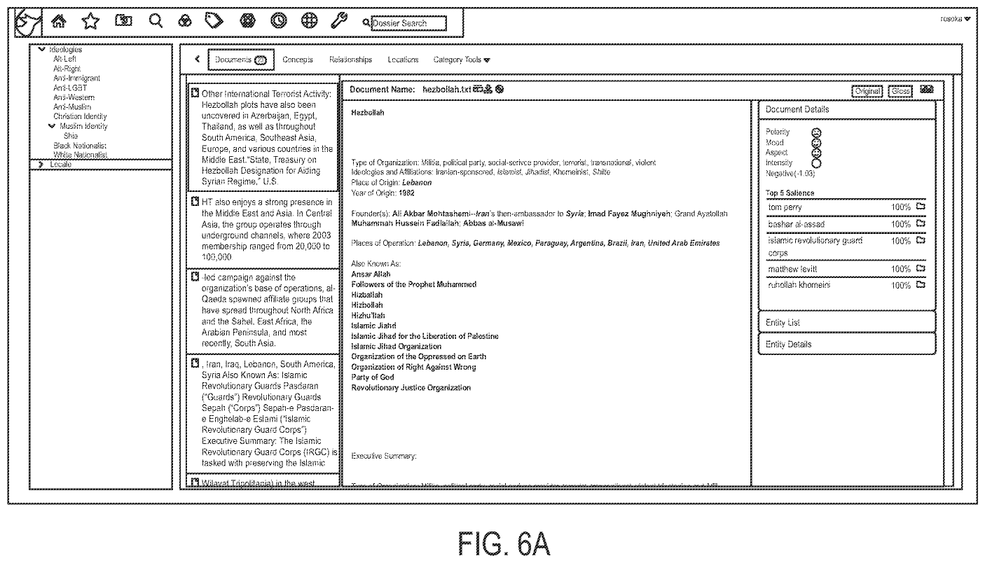

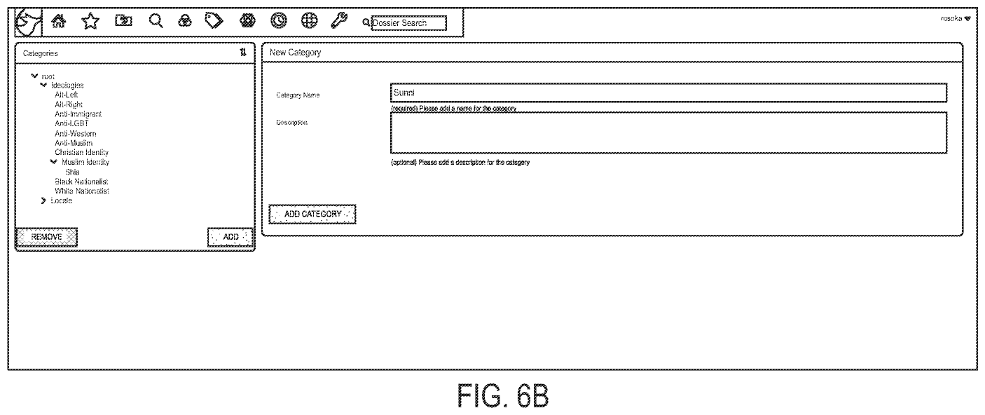

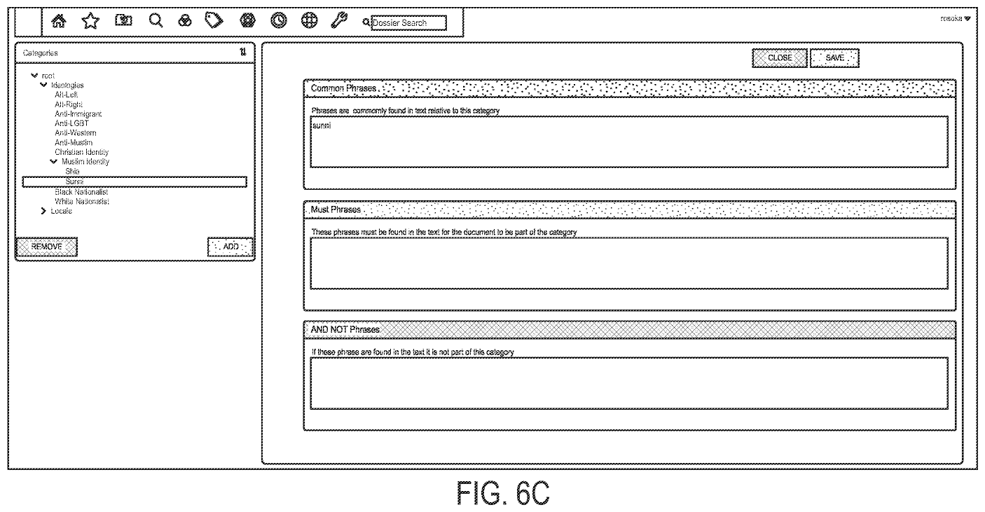

The category membership/exclusions may be relational between Entities. (e.g., PEOPLE associate to the FACILITY “Paris Hilton.” Alternatively, category membership/exclusions may be limited further by a relational subtype. For example, a category may be limited by PEOPLE ‘employed at’ the FACILITY “Paris Hilton.” FIGS. 6a-c illustrate an example dynamic categorization based on a semi-static classification taxonomy, according to certain embodiments. As shown in FIG. 6a, dynamic categorization incurs no down-time. As soon as the terms, concepts and entities are added, the categories are available for query regarding the terms, concepts, and entities.

FIG. 6a shows a semi-static classification taxonomy in the left-most pane. Curators can add new categories to the semi-static classification taxonomy. For example, FIG. 6b illustrates the document may include a category of “Sunni,” that was made immediately available for query.

FIG. 6c illustrates that a curator can add additional topics to the semi-static classification taxonomy and flesh out these categories, or extend existing categories, by adding terms, concepts, and entities that represent those categories. FIG. 6c shows the new category of “Sunni” with a new concept term of “sunni” added so that the category will be found in documents that contain the concept of “sunni.”

Certain embodiments are directed to an apparatus including at least one processor and at least one memory. The memory may include computer program code. The at least one memory and computer program code may be configured, with the at least one processor, to cause the apparatus at least to perform a method.

One having ordinary skill in the art will readily understand that the example embodiments as discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of example embodiments.

1. A method, comprising:
receiving a document at a natural language processing engine, wherein the natural language processing engine extracts text from the document;
indexing the extracted text at a data store;
populating a query based on the indexed text and a category descriptor; and
categorizing the document based on the query.

2. The method according to claim 1, wherein the natural processing engine identifies the language in the document and provides a base language meaning.

3. The method according to claim 1 or 2, wherein the natural language processing engine identifies entities in the document, concepts in the document, and relationships between the entities.

4. The method according to claim 3, wherein the natural language processing engine measures salience of each entity or concept.

5. The method according to any of claims 1-4, wherein documents are categorized by a cluster tool.

6. The method according to any of claims 1-5 further comprising:
constructing a category.

7. The method according to any of claims 1-6, wherein the extracted text from the natural language processing engine is used as consideration for the documents inclusion into or exclusion from a category.

8. The method according to claim 7, wherein the inclusion into or exclusion from a category of the document is not dependent on the indexed text.

9. The method according to any of claims 1-8, wherein the category descriptor comprises a list of terms that that include at least one of a must term, a should term, and a should not term.

10. An apparatus, comprising:
at least one processor; and
at least one memory comprising computer program code;
the at least one memory and computer program code configured, with the at least one processor, to cause the apparatus at least to perform
receiving a document at a natural language processing engine, wherein the natural language processing engine extracts text from the document;
indexing the extracted text at a data store;
populating a query based on the indexed text and a category descriptor; and
categorizing the document based on the query.

11. The apparatus according to claim 10, wherein the natural processing engine identifies the language in the document and provides a base language meaning.

12. The apparatus according to claim 10 or 11, wherein the natural language processing engine identifies entities in the document, concepts in the document, and relationships between the entities.

13. The apparatus according to claim 12, wherein the natural language processing engine measures salience of each entity or concept.

14. The apparatus according to any of claims 10-13, wherein documents are categorized by a cluster tool.

15. The apparatus according to any of claims 10-14, wherein the at least one memory and computer program code are further configured to perform:
constructing a category.

16. The apparatus according to any of claims 10-15, wherein the extracted text from the natural language processing engine is used as consideration for the documents inclusion into or exclusion from a category.

17. The apparatus according to claim 16, wherein the inclusion into or exclusion from a category of the document is not dependent on the indexed text.

18. The apparatus according to any of claims 10-17, wherein the category descriptor comprises a list of terms that that include at least one of a must term, a should term, and a should not term.

19. An apparatus, comprising:
circuitry configured to perform
receiving a document at a natural language processing engine, wherein the natural language processing engine extracts text from the document;
indexing the extracted text at a data store;
populating a query based on the indexed text and a category descriptor; and
categorizing the document based on the query.

20. The apparatus according to claim 19, wherein the natural processing engine identifies the language in the document and provides a base language meaning.

21. The apparatus according to claim 19 or 20, wherein the natural language processing engine identifies entities in the document, concepts in the document, and relationships between the entities.

22. The apparatus according to claim 21, wherein the natural language processing engine measures salience of each entity or concept.

23. The apparatus according to any of claims 19-22, wherein documents are categorized by a cluster tool.

24. The apparatus according to any of claims 19-23, wherein the circuitry is further configured to perform:
constructing a category.

25. The apparatus according to any of claims 19-24, wherein the extracted text from the natural language processing engine is used as consideration for the documents inclusion into or exclusion from a category.

26. The apparatus according to claim 25, wherein the inclusion into or exclusion from a category of the document is not dependent on the indexed text.

27. The apparatus according to any of claims 19-26, wherein the category descriptor comprises a list of terms that that include at least one of a must term, a should term, and a should not term.

28. An apparatus, comprising:
means for receiving a document at a natural language processing engine, wherein the natural language processing engine extracts text from the document;
means for indexing the extracted text at a data store;
means for populating a query based on the indexed text and a category descriptor; and
means for categorizing the document based on the query.

29. The apparatus according to claim 28, wherein the natural processing engine identifies the language in the document and provides a base language meaning.

30. The apparatus according to claim 28 or 29, wherein the natural language processing engine identifies entities in the document, concepts in the document, and relationships between the entities.

31. The apparatus according to claim 30, wherein the natural language processing engine measures salience of each entity or concept.

32. The apparatus according to any of claims 28-31, wherein documents are categorized by a cluster tool.

33. The apparatus according to any of claims 28-32 further comprising:
means for constructing a category.

34. The apparatus according to any of claims 28-33, wherein the extracted text from the natural language processing engine is used as consideration for the documents inclusion into or exclusion from a category.

35. The apparatus according to claim 34, wherein the inclusion into or exclusion from a category of the document is not dependent on the indexed text.

36. The apparatus according to any of claims 28-35, wherein the category descriptor comprises a list of terms that that include at least one of a must term, a should term, and a should not term.

37. A non-transitory computer readable medium comprising program instructions stored thereon that when executed in hardware, perform a method comprising:
receiving a document at a natural language processing engine, wherein the natural language processing engine extracts text from the document;
indexing the extracted text at a data store;
populating a query based on the indexed text and a category descriptor; and
categorizing the document based on the query.

38. The non-transitory computer readable medium according to claim 37, wherein the natural processing engine identifies the language in the document and provides a base language meaning.

39. The non-transitory computer readable medium according to claim 37 or 38, wherein the natural language processing engine identifies entities in the document, concepts in the document, and relationships between the entities.

40. The non-transitory computer readable medium according to claim 39, wherein the natural language processing engine measures salience of each entity or concept.

41. The non-transitory computer readable medium according to any of claims 37-40, wherein documents are categorized by a cluster tool.

42. The non-transitory computer readable medium according to any of claims 37-41, wherein the method further comprises performing:
constructing a category.

43. The non-transitory computer readable medium according to any of claims 37-42, wherein the extracted text from the natural language processing engine is used as consideration for the documents inclusion into or exclusion from a category.

44. The non-transitory computer readable medium according to claim 43, wherein the inclusion into or exclusion from a category of the document is not dependent on the indexed text.

45. The non-transitory computer readable medium according to any of claims 37-44, wherein the category descriptor comprises a list of terms that that include at least one of a must term, a should term, and a should not term.
